(19) United States
(12) Patent Application Publication
(10) Pub. No.: US 2024/0326640 A1
(43) Pub. Date: Oct. 3, 2024

(54) BATTERY SWAPPING STATION

(71) Applicants: AULTON NEW ENERGY AUTOMOTIVE TECHNOLOGY GROUP, Guangzhou, Guangdong (CN); SHANGHAI DIANBA NEW ENERGY TECHNOLOGY CO., LTD., Shanghai (CN)

(72) Inventors: Jianping Zhang, Guangzhou, Guangdong (CN); Xinyu Chen, Guangzhou, Guangdong (CN)

(21) Appl. No.: 18/270,218

(22) PCT Filed: Dec. 28, 2021
(86) PCT No.: PCT/CN2021/142115

§ 371 Date: Jan. 3, 2024

(30) Foreign Application Priority Data
Dec. 31, 2020 (CN) 202011628454.5

(51) Int. Cl. B60L 53/80; B60L 53/302; H02J 7/00

(52) U.S. Cl. CPC B60L 53/80; B60L 53/302; H02J 7/0045

(57) ABSTRACT

Provided is a battery swapping station, comprising: a battery swapping chamber, charging chambers and a first expansion compartment, wherein the battery swapping chamber is used for battery replacement for an electric vehicle; the charging chambers are located on left and right sides of a vehicle parking position in the battery swapping chamber and used for charging and discharging batteries; and the first expansion compartment is located above the battery swapping chamber, and the first expansion compartment is provided with an extension end that extends from the above of the battery swapping chamber in a running direction of the electric vehicle. The first expansion compartment enlarges the internal space of the battery swapping station, so as to provide more potential to allow the battery swapping station to have more functions.

The present application claims the priority of Chinese patent application 2020116284545 filed on Dec. 31, 2020. The contents of the Chinese patent application are incorporated herein by reference in their entireties.

### TECHNICAL FIELD

The present disclosure relates to the field of battery swapping, specifically to a battery swapping station.

### BACKGROUND

At present, battery swapping stations have been extensively utilized for battery replacement in electric vehicles. In the case of a single battery swapping station, the battery swapping efficiency can be improved by increasing the number of batteries that can be stored. Therefore, the number of battery compartments used to accommodate batteries and provide power to the batteries also increases. However, the more batteries are stored, the larger the battery storage area of the power swapping station requires. Existing battery swapping stations generally expand the battery storage area by assembling in the horizontal direction, which leads to a corresponding increase in the stroke of the battery swapping mechanism for transporting batteries between the battery swapping vehicle and each battery compartment, enlarged battery swapping station footprint, and suboptimal space utilization, making it challenging to implement the battery swapping stations on smaller land plots. At the same time, the battery swapping area used for battery swapping operations in the existing battery swapping station and the vehicle driving ramps located on both sides of the battery swapping area are exposed to the external environment and have no shelter. External rainwater or impurities are easy to enter the battery swapping area or vehicle driving ramps to affect the battery swapping operations, resulting in low battery swapping efficiency and easy damage to the battery swapping equipment.

### CONTENT OF THE PRESENT INVENTION

The technical problem to be solved by the present disclosure is to provide a battery swapping station in order to overcome the defect that battery swapping areas are not sheltered in battery swapping stations in the prior art.

The present disclosure solves the above-mentioned technical problem through the following technical solutions:
a battery swapping station, comprising:
a battery swapping chamber used for battery replacement for an electric vehicle;
charging chambers, wherein the charging chambers are located on both left and right sides of a vehicle parking position in the battery swapping chamber and used for charging and discharging batteries;
a first expansion compartment, wherein the first expansion compartment is located above the battery swapping chamber, and the first expansion compartment is provided with an extension end that extends from above the battery swapping chamber in a running direction of the electric vehicle.

In this solution, the first expansion compartment enlarges the internal space of the battery swapping station, so as to provide more potential to allow the battery swapping station to have more functions, for example, the added space can accommodate an air conditioner unit or the first expansion compartment can provide a rest place for workers and drivers, so as to improve the use experience of personnel. In addition, the extension end of the first expansion compartment shields the battery swapping chamber from wind and rain so as to reduce the impact of severe weather, such as wind, rain and sun, on the battery swapping chamber, so that the environment in the battery swapping station is relatively stable, which is favourable for prolonging the service life of the battery swapping station and improving the battery swapping stability.

Preferably, two sides of the battery swapping chamber are provided with a vehicle entrance and a vehicle exit, respectively, and the first expansion compartment is provided with two extension ends, and the two extension ends extend from above the vehicle entrance and the vehicle exit, respectively.

In this solution, the battery swapping chamber is communicated with the outside via the vehicle entrance and the vehicle exit. The extension ends, located above the vehicle entrance and the vehicle exit, plays a shielding role, preventing sunlight and precipitation from entering the open battery swapping chamber to a certain extent, thereby offering protection to an interior of the battery swapping chamber. At the same time, a vehicle, when waiting at the vehicle entrance for license plate recognition or to upload vehicle information, is immune to rainwater that may otherwise affect the operations.

Preferably, the vehicle entrance is provided with an uphill ramp, the vehicle exit is provided with a downhill ramp, and vertical projections of the two extension ends respectively cover the uphill ramp and the downhill ramp.

In this solution, the extension ends shelter the uphill ramp and the downhill ramp to prevent snow accumulation and icing during winter, avoiding vehicle skidding, and to provide rain cover in summer, ensuring that electric vehicles driving on the uphill ramp don't get wet. Some of the rainwater on the vehicle can be shaken off onto the uphill ramp, thereby reducing the amount of rainwater entering the battery swapping chamber.

Preferably, a side of the extension end is provided with a first material passage leading downward to ground, allowing external access to the first expansion compartment from outside the battery swapping station.

In this solution, personnel can enter the first expansion compartment on the second floor from outside the battery swapping station through the first material passage, without affecting the internal layout of the battery swapping station. Located on the side of the extension end, the material passage does not interfere with vehicle movement in and out of the battery swapping chamber, and also helps prevent personnel from being hit by an electric vehicle. The material passage can be a staircase, an escalator, an elevator, etc.

Preferably, the first material passage comprises a staircase extending obliquely downward from the side of the extension end to the ground to prevent the passage from blocking the vehicle entrance and the vehicle exit of the battery swapping chamber.

In this solution, the staircase is set at an angle, avoiding the vehicle entrance and the vehicle exit; a side of the staircase can be connected to the charging chamber to reinforce the staircase; if the battery swapping station has only one charging chamber, the staircase can also be positioned on a side without the charging chamber, offering a more compact layout for the battery swapping station. The staircase can be of a fixed type or retractable and when necessary, the staircase can be retracted, further reducing space occupied by the battery swapping station.

Preferably, a second expansion compartment is provided above the two charging chambers, and an interior space of the second expansion compartment is communicated with an interior space of the charging chamber, so that a lift in the charging chamber can be lifted to the interior of all the second expansion compartments, and/or a charging rack in the charging chamber can be extended to the interior of the second expansion compartment.

In this solution, by providing a second expansion compartment above the charging chamber, maximum storage capacity for batteries in the charging chamber can be increased, thereby increasing the number of batteries available for battery swapping in the battery swapping chamber, enhancing battery swapping efficiency while also saving ground space for the battery swapping station.

Preferably, the interior space of the second expansion compartment is communicated with the interior space of the first expansion compartment.

In this solution, the first expansion compartment on the second floor is interconnected with the second expansion compartment, so they can share a passage leading to the second floor, meeting maintenance and usage requirements. Additionally, space on the second floor is expanded, allowing for various layout options, such as placing an air conditioning unit communicated with the second expansion compartment in the first expansion compartment.

Preferably, a part of the charging rack in the charging chamber is preset in the charging chamber, while another part of the charging rack is preset in the second expansion compartment, and the two parts of the charging rack are connected when the expansion compartment is configured as above the charging chamber.

In this solution, by segmenting the charging rack and presetting two parts separately in the charging chamber and the second expansion compartment, the volume of the charging rack during transportation can be reduced, leading to cost savings.

Preferably, the charging rack is of a frame structure, and the two parts of the charging rack are connected via a vertical column of the frame structure.

In this solution, the two parts of the charging rack are connected via the vertical column of the frame structure, thereby reducing the alignment difficulty of the two parts of the charging rack at a construction site and enhancing the reliability after assembly.

Preferably, the charging chamber is provided with an air-conditioning ventilation duct, and the air-conditioning ventilation duct is located in an area of the charging chamber closing to the battery swapping chamber, and/or the air-conditioning ventilation duct is located in an area between the charging rack and the battery swapping chamber closing to the battery swapping chamber.

In this solution, the air-conditioning ventilation duct can avoid positions of the charging rack and the lift, and utilize a gap area between the charging chamber and the battery swapping chamber, thereby saving interior space of the charging chamber.

Preferably, the charging chamber is also provided with a main control cabinet, and the main control cabinet is situated in the air-conditioning ventilation duct, and an airflow in the air-conditioning ventilation duct passes through electrical components in the main control cabinet.

In this solution, the main control cabinet occupies the space in the air-conditioning ventilation duct on one hand, thereby saving space that would be occupied if placed externally. On the other hand, the main control cabinet is directly cooled by air-conditioning ventilation, reducing the occurrence of overheating malfunctions.

Preferably, an access opening is provided on the air-conditioning ventilation duct in an area corresponding to a control panel of the main control cabinet; a partition is provided between the charging chamber and the battery swapping chamber; a main control door is provided on the partition in an area corresponding to the control panel of the main control cabinet, and the access opening is communicated with the main control door, wherein the main control door of the main control cabinet is designed to open towards the battery swapping chamber.

In this solution, the main control cabinet opens towards the battery swapping chamber, which facilitates staff to control the main control cabinet from one side of the battery swapping chamber without entering the charging chamber, making operations more convenient. Furthermore, maintenance and installation can be accomplished outside the battery swapping chamber, eliminating the need to work in confined space of the charging chamber.

Preferably, a part of the air-conditioning ventilation duct is preset in the second expansion compartment, another part of the air-conditioning ventilation duct is preset in the charging chamber, and two parts of the air-conditioning ventilation duct are connected and communicated through a flexible joint.

In this solution, by segmenting the air-conditioning ventilation duct and presetting two parts separately in the charging chamber and the second expansion compartment, the workload on the construction site for installing interior components of the battery swapping station can be reduced, leading to a shorter on-site construction period. The two parts of the air-conditioning ventilation duct are connected through a flexible structure, allowing for reduced alignment difficulty on the construction site and improved reliability after connection.

Preferably, the charging chamber is also provided with a ventilation duct for a charger, and the charger is provided with a plug-in end for electrically connecting to a battery on the charging rack, wherein one end of the ventilation duct for the charger is positioned facing a different side from the plug-in end of the charger, and the other end of the ventilation duct for the charger is communicated with the outside of the charging chamber through a fan.

In this solution, the ventilation duct for the charger provides a separate airflow path to independently expel the heat generated by the charger from the charging chamber, thereby significantly reducing the heat in the charging chamber and preventing the heat from the charger from affecting other equipment in the charging chamber.

Preferably, the charging chamber is provided with at least two sets of the ventilation ducts for the chargers, each facing a different side from the plug-in ends of the two sets of chargers, and located on a side of the charger away from the lifting area, and the plug-in ends of the two sets of chargers are positioned opposite to each other, forming an operating area between the plug-in ends.

Preferably, a second material passage is provided between the first expansion compartment and the battery swapping chamber.

In this solution, the first expansion compartment can be accessed from the inside of the battery swapping chamber. When setting up the first expansion compartment, space of the battery swapping chamber can be utilized. Furthermore, maintenance on the battery swapping chamber can be done from the first expansion compartment.

Preferably, the battery swapping chamber comprises an independent compartment at the top and a driving passage at the bottom, and the independent compartment is communicated with the first expansion compartment.

In this solution, space utilization of the battery swapping chamber is high. The driving passage is used for electric vehicles to move through, while the independent compartment can be used for arranging pipelines, such as pipelines connected to the first expansion compartment, or for accommodating items from the first expansion compartment, thereby increasing usable space of the first expansion compartment.

Preferably, the battery swapping station is provided with at least two battery swapping chambers arranged side by side in the running direction of the electric vehicle; opposite sides of each of the battery swapping chambers are provided with the charging chamber; end surfaces of the first expansion compartments located above each of the battery swapping chamber are connected, and a plurality of the first expansion compartments are internally communicated.

In this solution, side-by-side arrangement of the battery swapping chambers saves the ground space occupied by the battery swapping station, and allows for simultaneous battery replacement in multiple vehicles, increasing battery swapping efficiency. By interconnecting multiple first expansion compartments, more space above the battery swapping chambers can be utilized to support a broader range of applications.

Preferably, a second expansion compartment is provided above the charging chamber, and the bottom of the second expansion compartment is communicated with the top of the charging chamber.

In this solution, the second expansion compartment can increase the maximum storage capacity for batteries in the charging chamber, thereby increasing the number of batteries available for battery swapping in the battery swapping chamber, enhancing the efficiency of battery swapping while also saving the ground space occupied by the battery swapping station.

Preferably, a third expansion compartment is provided between adjacent charging chambers along the running direction of the electric vehicle in the battery swapping station, and the third expansion compartment is provided with a passage door for the electric vehicle to drive out.

In this solution, the third expansion compartment can be used for installing relevant equipment of the battery swapping station. Alternatively, the third expansion compartment can be left unoccupied, allowing electric vehicles that have completed the battery-swapping process to exit through the third expansion compartment, thereby improving battery swapping efficiency.

On the basis of conforming to common knowledge in the art, the above-mentioned preferred conditions can be combined arbitrarily to obtain preferred examples of the present disclosure.

The positive progressive effects of the present disclosure lie in that: the first expansion compartment enlarges the internal space of the battery swapping station, so as to provide more potential to allow the battery swapping station to have more functions, and can be used for accommodating an air conditioner unit or providing a rest place for workers and drivers. At the same time, the extension end of the first expansion compartment shields the battery swapping chamber from wind and rain so as to reduce the impact of severe weather, such as wind, rain and sun, on the battery swapping chamber, so that the environment in the battery swapping station is relatively stable, which is favourable for prolonging the service life of the battery swapping station and improving the battery swapping stability.

### BRIEF DESCRIPTION OF THE DRAWINGS

FIG. 1 is a schematic diagram illustrating the overall structure of a battery swapping station according to example 1 of the present disclosure.

FIG. 2 is another schematic diagram illustrating the overall structure of the battery swapping station according to example 1 of the present disclosure.

FIG. 3 is a schematic diagram illustrating the internal structure of a full-featured compartment of the battery swapping station according to example 1 of the present disclosure.

FIG. 4 is a schematic diagram illustrating the overall internal layout of the battery swapping station according to example 1 of the present disclosure.

FIG. 5 is a partially enlarged schematic diagram illustrating the internal layout of the battery swapping station according to example 1 of the present disclosure.

FIG. 6 is a schematic diagram illustrating the structure of an air-conditioning ventilation duct of the battery swapping station according to example 1 of the present disclosure.

FIG. 7 is a schematic diagram illustrating the overall structure of a battery swapping station according to example 2 of the present disclosure.

FIG. 8 is another schematic diagram illustrating the overall structure of the battery swapping station according to example 2 of the present disclosure.

### DESCRIPTION OF REFERENCE NUMERALS

| | |
|---|---|
| battery swapping chamber 101; | charging chamber 102; |
| battery swapping passage 103; | lifting area 104; |
| operating area 105; | partition 106; |
| full-featured compartment 11; | first expansion compartment 110; |
| extension end 111; | second expansion compartment 120; |
| third expansion compartment 130; | passage door 131; |
| first material passage 10; | maintenance door 13; |
| main control door 14; | independent compartment 21; |
| driving passage 22; | air conditioner indoor unit 31; |
| air conditioner outdoor unit 32; | air-conditioning ventilation 4; |
| lower air duct 41; | upper air duct 42; |
| joint connector 43; | exhaust duct 44; |
| charging rack 5; | charger 51; |
| ventilation duct for charger 52; | lift 6; |
| main control cabinet 71; | uphill ramp 81; |
| downhill ramp 82; | walking platform 9. |

### DETAILED DESCRIPTION OF THE PREFERRED EMBODIMENT

The present disclosure is further described below by way of examples, but the present disclosure is not limited to the scope of the described examples.

### Example 1

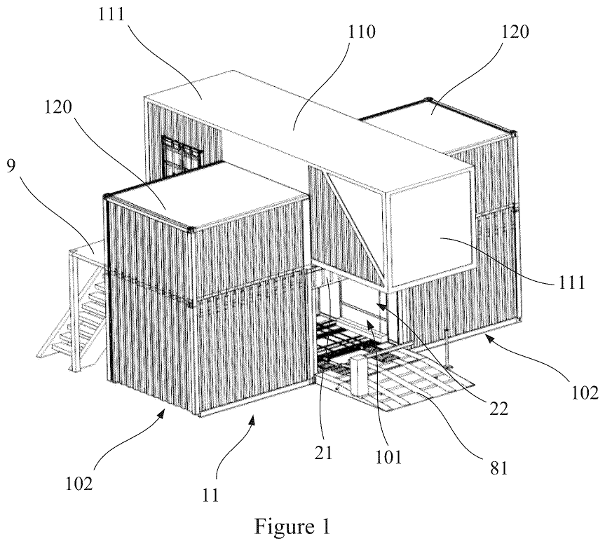

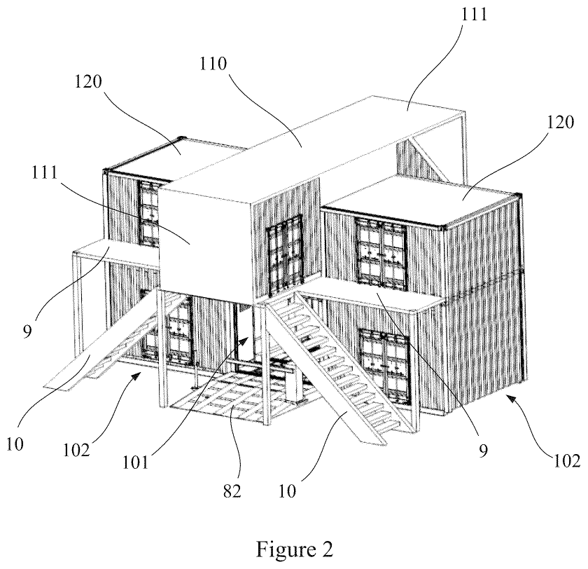

As shown in FIGS. 1 and 2, this example provides a battery swapping station including a full-featured compartment 11. The full-featured compartment 11 comprises a battery swapping chamber 101 and charging chambers 102, wherein the battery swapping chamber 101 is used for battery replacement for an electric vehicle, and the charging chambers 102 are located on left and right sides of a vehicle parking position in the battery swapping chamber 101 and used for charging and discharging the batteries.

In other embodiments, the full-featured compartment 11 may comprise only one battery swapping chamber 101 and one charging chamber 102. It may also be arranged that two or more battery swapping chambers 101 share a single charging chamber 102, or two or more battery swapping chambers 101 cooperate with two or more charging chambers 102.

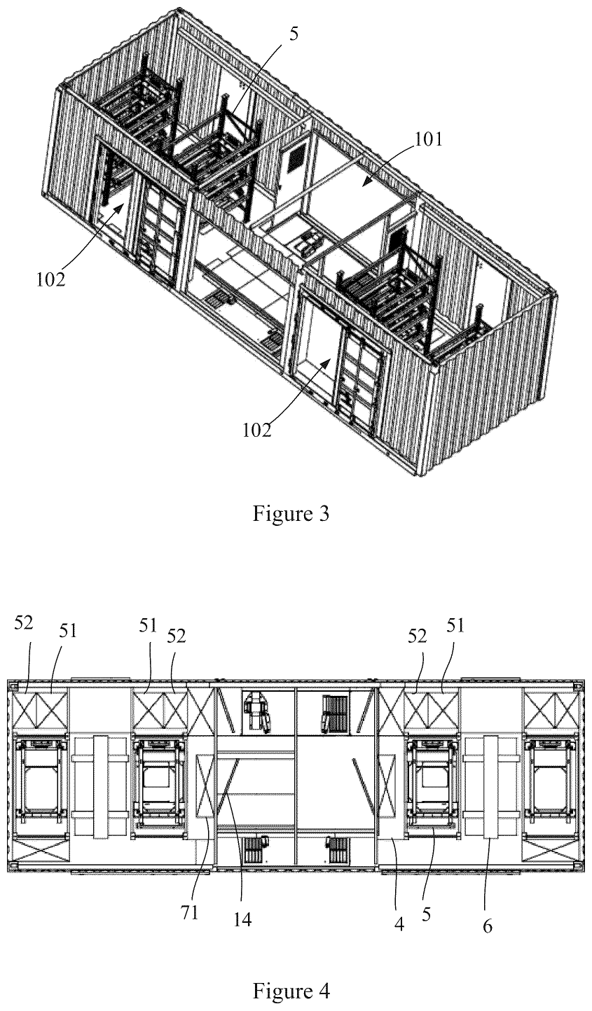

As shown in FIG. 3, the battery swapping station of this example comprises the battery swapping chamber 101 used for battery replacement for the electric vehicle and at least two charging chambers 102 for battery charging and discharging, and the charging chambers 102 are respectively positioned on the left and right sides of the vehicle parking position in the battery swapping chamber 101. A battery swapping passage 103 is provided between the charging chamber 102 and the battery swapping chamber 101 for battery swapping equipment to enter and exit. The battery swapping passage 103 is provided with a battery swapping passage door used to open as the battery swapping equipment shuttles back and forth, and to close after the battery swapping equipment completes the battery swapping.

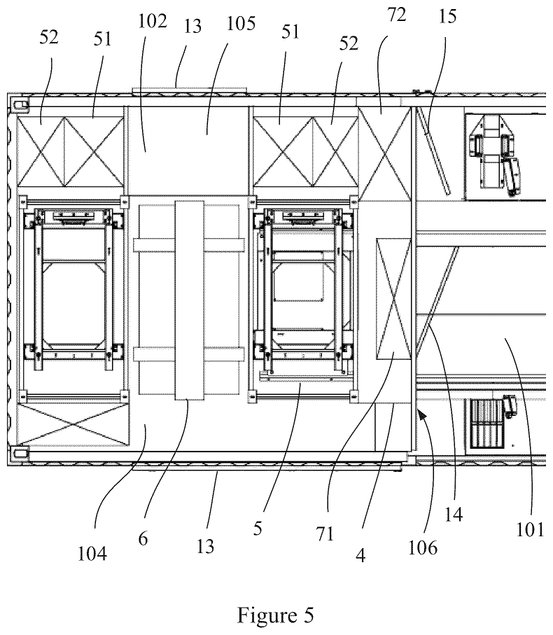

As shown in FIGS. 4 and 5, the charging chamber 102 is provided with a charger 51 for charging and discharging batteries, a lift 6 for retrieving and placing batteries, and battery swapping equipment that travels between the charging chamber 102 and the battery swapping chamber 101 to replace batteries in electric vehicles. In the charging chamber 102, at least 2 rows of charging racks 5 are arranged side by side, perpendicular to the running direction of the vehicle. The lift 6 is located in a lifting area 104 between the two rows of the charging racks 5, and the charger 51 is provided at one side of the charging racks 5.

In other embodiments, an alternative set-up may be multiple rows of charging racks 5 or a single row of charging rack 5. The lift 5 may be a stacker that can move both horizontally and vertically, or a device designed to transport batteries only in the vertical direction, or a device designed to transport batteries only in the horizontal direction.

In this example, an expansion compartment is provided above the full-featured compartment 11. Specifically, the battery swapping station further comprises a first expansion compartment 110, and the first expansion compartment 110 is located above the battery swapping chamber 101. The first expansion compartment 110 enlarges the internal space of the battery swapping station, so as to provide more potential to allow the battery swapping station to have more functions. For instances, the added space can be utilized to accommodate an air conditioning unit; alternatively, the first expansion compartment 110 can provide a rest place for workers and drivers, enhancing user experience.

Moreover, the first expansion compartment 110 is provided with an extension end 111 that protrudes from above the battery swapping chamber 101 in a running direction of electric vehicles. The extension end 111 of the first expansion compartment 110 shields the battery swapping chamber 101 from wind and rain so as to reduce the impact of severe weather, such as wind, rain and sun, on the battery swapping chamber 101, so that the environment in the battery swapping station 101 is relatively stable, which is favourable for prolonging the service life of the battery swapping station and improving the battery swapping stability. Depending on the specific conditions of the construction site, the first expansion compartment 110 may be provided with only one extension end 111 (for example, if there is already a rain-proof facility on one side of the battery swapping chamber on-site, only one extension end may be provided). In some preferred embodiments, extension ends 111 may be provided on both sides of the first expansion compartment 110.

In other embodiments, the battery swapping station may also comprises only one full-featured compartment 11, with the top of the full-featured compartment 11 closed. When expansion is needed, the expansion compartment is connected to the top of the full-featured compartment.

In this example, two sides of the battery swapping chamber 101 are provided with a vehicle entrance and a vehicle exit, respectively. Electric vehicles can drive into the battery swapping chamber 101 through the vehicle entrance for battery replacement, and out through the vehicle exit after battery swapping is finished. The first expansion compartment 110 is provided with two extension ends 111, and the two extension ends 111 extend from above the vehicle entrance and the vehicle exit, respectively. The battery swapping chamber 101 is communicated with the outside via the vehicle entrance and the vehicle exit. The extension ends 111, located above the vehicle entrance and the vehicle exit, plays a shielding role, preventing sunlight and precipitation from entering the open battery swapping chamber 101 to a certain extent, thereby offering protection to an interior of the battery swapping chamber 101. Additionally, a vehicle, when waiting at the vehicle entrance for license plate recognition or to upload vehicle information, is immune to rainwater that may otherwise affect the operations.

The vehicle entrance is provided with an uphill ramp 81, while the vehicle exit is provided with a downhill ramp 82. The uphill ramp 81, the battery swapping chamber 101, and the downhill ramp 82 constitutes a vehicle passage. Vertical projections of the two extension ends 111 respectively cover the uphill ramp 81 and the downhill ramp 82. The extension ends 111 shelter the uphill ramp 81 and the downhill ramp 82 to prevent snow accumulation and icing during winter, avoiding vehicle skidding, and to provide rain cover in summer, ensuring that electric vehicles driving on the uphill ramp 81 don't get wet, and some of the rainwater on the vehicle can drip off onto the uphill ramp 81, thereby reducing the amount of rainwater entering the battery swapping chamber 101 and improving the interior environment of the battery swapping chamber 101.

As shown in FIG. 2, a side of the extension end 111 is provided with a first material passage 10 leading downward to the ground, allowing external access to the first expansion compartment 110 from outside the battery swapping station. Personnel can enter the first expansion compartment 110 on the second floor from outside the battery swapping station through the first material passage 10, without affecting internal layout of the battery swapping station. Located on the side of the extension end 111, the material passage does not interfere with vehicle movement in and out of the battery swapping chamber 101. Moreover, the movement routes of personnel do not overlap with the movement routes of vehicles, thus realizing the separation of people and vehicles and preventing people from being hit by electric vehicles. The material passage can be a staircase, an escalator, an elevator, etc.

The first material passage 10 comprises a staircase extending obliquely downward from the side of the extension end 111 to the ground to prevent the passage from blocking the vehicle entrance and the vehicle exit of the battery swapping chamber 101. The staircase is set at an angle, avoiding the vehicle entrance and the vehicle exit; a side of the staircase can be connected to the charging chamber 102 to reinforce the staircase; if the battery swapping station has only one charging chamber 102, the staircase can also be positioned on a side without the charging chamber 102, offering a more compact layout for the battery swapping station. The staircase can be of a fixed type or retractable and when necessary, the staircase can be retracted, further reducing the space occupied by the battery swapping station. For instance, when performing maintenance on the charging chamber 102, the retracted staircase can make room on the side of the charging chamber 102. In this example, as shown in FIG. 2, two sides of the extension end 111 are each provided with a staircase, allowing personnel to take separate paths up and down, thereby reducing congestion. In some preferred examples, the two extension ends 111 of the first expansion compartment 110 can each be provided with a first material passage 10.

A second expansion compartment 120 is provided above the two charging chambers 102, and an interior space of the second expansion compartment 120 is communicated with an interior space of the charging chamber 102, so that a lift 6 in the charging chamber 102 can be lifted to the interior of all the second expansion compartments 120, and the charging rack 5 in the charging chamber 102 can be extended to the interior of the second expansion compartment 120. By providing the second expansion compartment 120 above the charging chamber 102, maximum storage capacity for batteries in the charging chamber 102 can be increased, thereby increasing the number of batteries available for battery swapping in the battery swapping chamber 101, enhancing battery swapping efficiency while also saving ground space for the battery swapping station.

In the case of a single charging rack 5, a part of the charging rack in the charging chamber is preset in the charging chamber, while another part of the charging rack is preset in the expansion compartment, and two parts of the charging rack are connected when the expansion compartment is provided above the charging chamber. Specifically, the charging rack can be divided into an upper rack body and a lower rack body which are independent from each other. The upper rack body is preset in the second expansion compartment 120, while the lower rack body is preset in the charging chamber 102. These two parts of the charging rack 5 are connected when the second expansion compartment 120 is provided above the charging chamber 102. By segmenting the charging rack 5 and presetting two parts separately in the charging chamber 102 and the second expansion compartment 120, the volume of the charging rack 5 during transportation can be reduced, leading to cost savings. The charging rack 5 is of a frame structure, and the two parts of the charging rack are connected via a vertical column of the frame structure. The top of the vertical column in the lower rack body installed on one side of the full-featured compartment 11 is provided with a connection part for the charging rack. The connection part provides a connection interface to enable detachable connections between the upper and lower rack bodies. The connection part for the charging rack can be one or more of a flange connection part, a buckle connection part, a threaded fastener, and a welded connection part.

In other alternative embodiments, two or more second expansion compartments 120 can be stacked above each of the charging chambers 102 to provide more space for battery storage. Multiple second expansion compartments 120 are stacked successively above the charging chamber 102 in the height direction. The bottom space of and the top space of adjacent second expansion compartments 120 are communicated with each other, so that the lift in the charging chamber can be lifted and lowered to the interior of all the expansion compartments. The charging racks in the charging chamber 102 can extend into the interior of all the expansion compartments, further increasing the maximum number of batteries that can be stored in the charging chamber 102. The bottom space of the topmost second expansion compartment 120 is communicated with the top space of the adjacent second expansion compartment 120 or the charging chamber 102 below. The top and bottom spaces of the second expansion compartments 120 in between are communicated with the adjacent second expansion compartments 120 or charging chamber 102 both above and below. At the same time, by altering the arrangement scheme of the quantity of the second expansion compartments 120, the number of batteries that can be stored in the battery swapping station can be adjusted in a simple and quick manner, so as to improve the modularity of the battery swapping station and improves its expandability.

The interior space of the second expansion compartment 120 is communicated with an interior space of the first expansion compartment 110. The first expansion compartment 110 on the second floor is interconnected with the second expansion compartment 120, so they can share a passage leading to the second floor, meeting maintenance and usage requirements. Additionally, the space on the second floor is expanded, allowing for various layout options, such as placing an air conditioning unit communicated with the second expansion compartment 120 in the first expansion compartment 110.

A walking platform 9 is provided between the extension end 111 of the first expansion compartment 110 and the second expansion compartment 120, and both the extension end 111 and the second expansion compartment 120 are provided with a door facing the walking platform 9. Therefore, one can enter the second expansion compartment 120 from the first expansion compartment 110 from outside the battery swapping station. As a preferred embodiment, the first material passage 10 is communicated with the walking platform 9, thereby allowing direct entry into the second expansion compartment 120 through the first material passage 10.

A part of the charging rack 5 in the charging chamber 102 is preset in the charging chamber 102, while another part of the charging rack 5 is preset in the second expansion compartment 120, and two parts of the charging rack 5 are connected when the expansion compartment is provided above the charging chamber 102. By segmenting the charging rack 5 and presetting two parts separately in the charging chamber 102 and the second expansion 120 compartment, the volume of the charging rack 5 during transportation can be reduced, leading to cost savings. As a preferred embodiment, the top of the charging rack 5 in the charging chamber 102 is provided with a connection part for the charging rack 5 for connecting the charging rack 5 in the second expansion compartment 120, allowing the upper and lower charging racks 5 to be conveniently and reliably connected.

The charging rack 5 is of a frame structure, and the two parts of the charging rack 5 are connected via a vertical column of the frame structure. The two parts of the charging rack 5 are connected via the vertical column of the frame structure, thereby reducing the alignment difficulty of these two parts of the charging rack 5 at the construction site and enhancing the reliability after assembly. Specifically, as mentioned above, a connector for the charging rack 5 is provided between the upper and lower sections of the vertical column.

As shown in FIG. 4 and FIG. 5, the charging chamber 102 in this example is provided with an air-conditioning ventilation duct 4, and the air-conditioning ventilation duct 4 is located in an area of the charging chamber 102 closing to the battery swapping chamber 101. In other embodiments, the air-conditioning ventilation duct 4 of this example is located in an area between the charging rack 5 and the battery swapping chamber 101 closing to the battery swapping chamber 101. As such, the air-conditioning ventilation duct can avoid the positions of the charging rack 5 and the lift 6, and utilizes the gap area between the charging chamber 102 and the battery swapping chamber 101, thereby saving interior space of the charging chamber 102.

As shown in FIG. 4 and FIG. 5, the charging chamber 102 is also provided with a main control cabinet 71, and the main control cabinet 71 is situated in the air-conditioning ventilation duct 4, and an airflow in the air-conditioning ventilation duct 4 passes through electrical components in the main control cabinet 71. The main control cabinet 71 occupies the interior space in the air-conditioning ventilation duct 4 on one hand, thereby saving space that would be occupied if placed externally. On the other hand, the main control cabinet is directly cooled by the air-conditioning ventilation, reducing the occurrence of overheating malfunctions.

As shown in FIG. 5, an access opening is provided on the air-conditioning ventilation duct 4 of the present disclosure in an area corresponding to a control panel of the main control cabinet 71; a partition 106 is provided between the charging chamber 102 and the battery swapping chamber 101; a main control door 14 is provided on the partition 106 in an area corresponding to the control panel of the main control cabinet 71, and the access opening is communicated with the main control door 14, wherein the main control door 14 of the main control cabinet 71 is designed to open towards the battery swapping chamber 101. The main control cabinet 71 opens towards the battery swapping chamber 101, which facilitates staff to control the main control cabinet 71 from one side of the battery swapping chamber 101 without entering the charging chamber 102, making operations more convenient. Furthermore, maintenance on and installation of the main control cabinet 71 can be accomplished outside the battery swapping chamber 101, eliminating the need to work in confined space of the charging chamber 102. In other examples, a communication cabinet or a switch can also be placed near other outward-facing walls of the charging chamber 102, and a switch door is provided on the outward-facing wall to facilitate opening from the outside.

In other embodiments, the main control cabinet 71 and the charger 51 may be respectively disposed on opposite sides of the charging rack along the vehicle traveling direction. The main control cabinet 71 is located on a side of the charging chamber 102 close to the vehicle drive-in direction, while the charger 51 is located on a side of the charging chamber 102 in the vehicle drive-out direction. As the main control cabinet 71 and the charger 51 occupy a large space, they are respectively positioned on either side of the charging rack to avoid each other and prevent space crowding. Moreover, in order to adapt to the position of the battery on the electric vehicle, the charging chamber 102 has a larger space on the side close to the vehicle drive-out direction is consequently larger. Therefore, it is preferable to place the charger 51 on the side of the charging rack close to the vehicle drive-out direction.

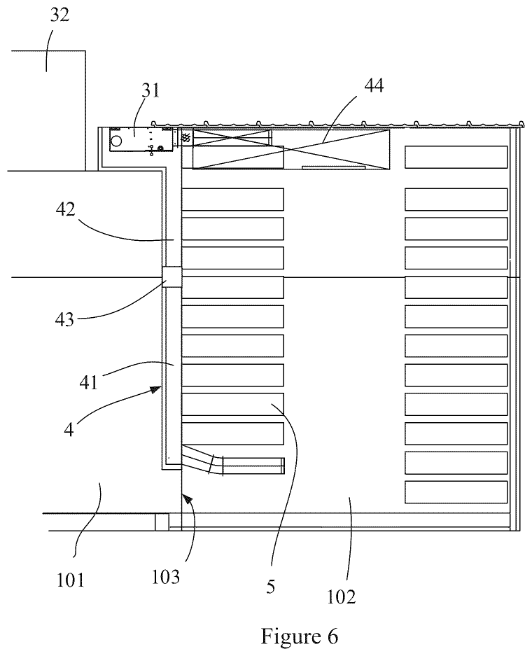

As shown in FIG. 6, the full-featured compartment 11 also comprises an air conditioner outdoor unit 32 and an air conditioner indoor unit 31, wherein the air conditioner outdoor unit 32 is provided above the full-featured compartment 11, and the air conditioner indoor unit 31 is located on the one side of the charging rack 5. The charging chamber 102 is further provided with an air-conditioning ventilation duct 4. The air inlet duct (lower air duct 41 and upper air duct 42) of the air-conditioning ventilation duct 4 is provided between the charging rack 5 and the charging chamber 101. One end of the air inlet duct (lower air duct 41 and upper air duct 42) is connected to the bottom of the charging chamber 102, while the other end is connected to the air inlet of the air conditioner outdoor unit 31. The exhaust duct 44 of the air-conditioning ventilation duct 4 is located at the top of the charging chamber 102. The air-conditioning ventilation duct 4 allows for a circulation of exhausting and intaking air, enabling sufficient cooling of the charging chamber 102, thereby reducing the occurrence of battery pack overheating. The heat from the air conditioner outdoor unit 32 is directly discharged to the outside without affecting the interior of the full-featured compartment 11. A certain gap is reserved between the bottom of the air inlet duct, that is, the bottom of the lower air duct 41, and the bottom surface of the charging chamber 102 to avoid the battery swapping equipment in the charging chamber 102.

As shown in FIG. 6, the lower air duct 41 of the air-conditioning ventilation duct 4 is preset in the full-featured compartment 11, and the upper air duct 42 of the air-conditioning ventilation duct 4 is preset in either the first expansion compartment 110 or the second expansion compartment 120. The two parts of the air-conditioning ventilation duct 4 are connected and communicate through a connector 43 (i.e., the air-conditioning ventilation duct connector). By way of presetting, the air-conditioning ventilation duct 4 does not need to be installed from scratch during assembly, but only requires a connector for linkage. The connector 43 can be a flange, or one or more of a hard tube, a soft tube, and a corrugated tube. The upper air duct 42 and lower air duct 41 are connected together through methods such as docking, thread fastening, or welding.

As shown in FIGS. 4 and 5, in this example, the charging chamber 102 is also provided with a ventilation duct 52 for a charger, and the charger 51 is provided with a plug-in end for electrically connecting to a battery, wherein one end of the ventilation duct 52 for the charger is positioned facing a different side from the plug-in end of the charger 51, and the other end of the ventilation duct 52 for the charger is communicated with the outside of the charging chamber 102 through a fan. As a result, the ventilation duct 52 for the charger provides a separate airflow pathway, allowing the heat generated by the charger 51 during charging to be independently expelled from the charging chamber 102, thereby reducing the impact of the heat produced by the charger 51 on the interior environment, greatly reducing the temperature in the charging chamber 102, and avoiding the heat of the charger 51 from affecting other equipment in the charging chamber 102.

The top of the ventilation duct 52 for the charger located in the charging chamber 102 of the full-featured compartment 11 may also be provided with a connection part of the ventilation duct for the charger designed for expansion connection. The connection part of the ventilation duct for the charger is used to further connect the increased expansion section of the ventilation duct for the charger, allowing part of the ventilation duct 52 for the charger to extend into the interior of the second expansion compartment 120. That is, a portion of the expansion section of the ventilation duct for the charger, which is preset in the second expansion compartment 120, is connected to the ventilation duct 52 for the charger in the full-featured compartment 11 through the connection part of the ventilation duct for the charger. The connection part for the charging ventilation duct can be one or more of a flange connection part, a buckle connection part, a threaded fastener, or a welded connection part.

As shown in FIGS. 4 and 5, in this example, the ventilation duct 52 for the charger is located on the side of the charger 51 away from the lifting area 104. The charging chamber 102 is provided with at least two sets of the ventilation ducts 52 for the chargers, each facing a different side from the plug-in ends (i.e., the side of the charger 51 facing the operating area in FIG. 5) of the two sets of chargers 51, and located on a side of the charger 51 away from the lifting area 104, and the plug-in ends of the two sets of chargers 51 are positioned opposite to each other, forming an operating area 105 between the plug-in ends.

As shown in FIG. 5, the charger 51 is provided in the maintenance door 13 of the charging chamber 102. The operation area 105 can be entered by opening the maintenance door on the upper side in FIG. 5. The maintenance door 13 set in this manner is convenient for workers to open outside the full-featured compartment 11 without entering the charging chamber 102, making it convenient for operation. Furthermore, maintenance on and installation of the charger 51 can be accomplished in the operating area 105, even from outside the battery swapping chamber 102, eliminating the need to work in confined space of the charging chamber 102.

A second material passage (not shown in the figure) is provided between the first expansion compartment 110 and the battery swapping chamber 101. Through the second material passage, items can be transferred between the first expansion compartment 110 and the battery swapping chamber 101. For instance, users can select items stored in the first expansion compartment 110 from the battery swapping chamber. The item is transferred to the battery swapping chamber via the second material passage. The second material passage can be a vertically lifting platform or other mechanisms that can move vertically.

The battery swapping chamber 101 comprises an independent compartment 21 at the top and a driving passage 22 at the bottom, and the independent compartment 21 is communicated with the first expansion compartment 110. As such, space utilization of the battery swapping chamber 101 is high. The driving passage 22 at the bottom is used for electric vehicles to move through, while the independent compartment 21 at the top can be used for arranging pipelines, such as pipelines connected to the first expansion compartment 110, or for providing versatile spaces like a lounge, or for accommodating items from the first expansion compartment, thereby increasing the usable space of the first expansion compartment.

### Example 2

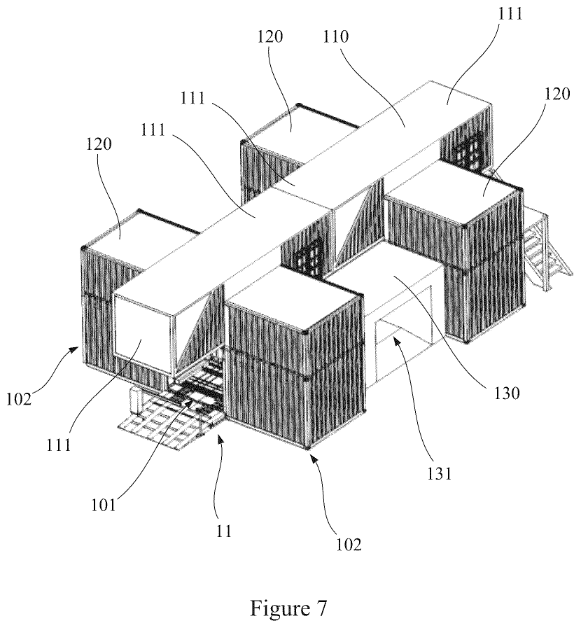

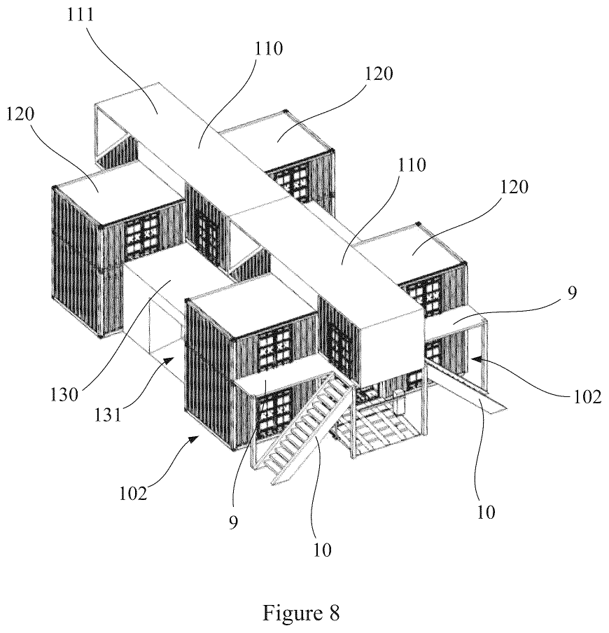

As shown in FIG. 7 and FIG. 8, example 2, based on example 1, provides a battery swapping station provided with at least two battery swapping chambers 101 arranged side by side in the running direction of the electric vehicles; opposite sides of each of the battery swapping chambers 101 are provided with charging chambers 102; end surfaces of the first expansion compartments 110 located above each of the battery swapping chambers 101 are connected, and the plurality of the first expansion compartments 110 are internally communicated. The side-by-side arrangement of the battery swapping chambers 101 saves the ground space occupied by the battery swapping station, and allows for simultaneous battery replacement in multiple vehicles, increasing the battery swapping efficiency; by interconnecting multiple first expansion compartments 110, more space above the battery swapping chambers 101 can be utilized to support a broader range of applications. For example, in example 1, the space of a single first expansion compartment 110 can only accommodate a few vending machines. However, in example 2, the combined space of two first expansion compartments 110 can be used to establish a supermarket, offering a wider range of services.

Similar to example 1, in example 2, a second expansion compartment 120 is provided above the charging chamber 102, and the bottom of the second expansion compartment 120 is communicated with the top of the charging chamber 102. The second expansion compartment 120 can increase the maximum storage capacity for batteries in the charging chamber 102, thereby increasing the number of batteries available for battery swapping in the battery swapping chamber 101, enhancing battery swapping efficiency while also saving ground space for the battery swapping station.

A third expansion compartment 130 is provided between adjacent charging chambers 102 along the running direction of electric vehicles in the battery swapping station, and the third expansion compartment 130 is provided with a passage door 131 for electric vehicles to drive out. The third expansion compartment 130 can be used for installing relevant equipment of the battery swapping station. Alternatively, the third expansion compartment 130 can be left unoccupied, allowing electric vehicles that have completed the battery-swapping process to exit through the third expansion compartment 130, thereby improving battery swapping efficiency.

Further, a fourth expansion compartment (not shown in the figure) may also be provided above the third expansion compartment 130. The fourth expansion compartment can be communicated with the first expansion compartment 110. The function of the fourth expansion compartment is similar to that of the first expansion compartment 110. It can be used for installing service-related facilities as well as equipment related to battery swapping.

Only one first expansion compartment 110 may be provided with the first material passage 10. For example, as shown in FIG. 8, two first material passages 10 connected to the same first expansion compartment 110 are provided at one side of the battery swapping station, thereby saving space. Each first expansion compartment 110 may also be provided with the first material passage 10. For instance, the first material passages 10 are provided at both sides of the battery swapping station, or one first material passage 10 connected to the junction of two first expansion compartments 110 is provided.

Although specific embodiments of the present disclosure have been described above, those skilled in the art should understand that these are merely illustrative examples. The scope of protection of the present disclosure is defined by the appended claims. Those skilled in the art can make various changes or modifications to these embodiments without departing from the principle and essence of the present disclosure, but these changes and modifications all fall in the scope of protection of the present disclosure.

1. A battery swapping station, comprising:
a battery swapping chamber used for battery replacement for an electric vehicle;
charging chambers, wherein the charging chambers are located on both left and right sides of a vehicle parking position in the battery swapping chamber and used for charging and discharging batteries;
a first expansion compartment, wherein the first expansion compartment is located above the battery swapping chamber, and the first expansion compartment is provided with an extension end that extends from above the battery swapping chamber in a running direction of the electric vehicle.

2. The battery swapping station according to claim 1, wherein two sides of the battery swapping chamber are provided with a vehicle entrance and a vehicle exit respectively, and the first expansion compartment is provided with the two extension ends, and the two extension ends extend from above the vehicle entrance and the vehicle exit respectively.

3. The battery swapping station according to claim 2, wherein the vehicle entrance is provided with an uphill ramp, the vehicle exit is provided with a downhill ramp, and the vertical projections of the two extension ends respectively cover the uphill ramp and the downhill ramp.

4. The battery swapping station according to claim 1, wherein a side of the extension end is provided with a first material passage leading downward to ground, allowing external access to the first expansion compartment from outside the battery swapping station.

5. The battery swapping station according to claim 4, wherein the first material passage comprises a staircase extending obliquely downward from the side of the extension end to the ground to prevent the passage from blocking the vehicle entrance and the vehicle exit of the battery swapping chamber.

6. The battery swapping station according to claim 1, wherein a second expansion compartment is provided above the two charging chambers, and an interior space of the second expansion compartment is communicated with an interior space of the charging chamber, so that a lift in the charging chamber can be lifted to the interior of all the second expansion compartments, or a charging rack in the charging chamber can be extended to the interior of the second expansion compartment.

7. The battery swapping station according to claim 6, wherein the interior space of the second expansion compartment is communicated with the interior space of the first expansion compartment.

8. The battery swapping station according to claim 6, wherein a part of the charging rack in the charging chamber is preset in the charging chamber, while another part of the charging rack is preset in the second expansion compartment, and the two parts of the charging rack are connected when the expansion compartment is configured as above the charging chamber.

9. The battery swapping station according to claim 8, wherein the charging rack is of a frame structure, and the two parts of the charging rack are connected via a vertical column of the frame structure.

10. The battery swapping station according to claim 6, wherein the charging chamber is provided with an air-conditioning ventilation duct, and the air-conditioning ventilation duct is located in an area of the charging chamber closing to the battery swapping chamber, or the air-conditioning ventilation duct is located in an area between the charging rack and the battery swapping chamber closing to the battery swapping chamber.

11. The battery swapping station according to claim 10, wherein the charging chamber is also provided with a main control cabinet, and the main control cabinet is situated in the air-conditioning ventilation duct, and an airflow in the air-conditioning ventilation duct passes through electrical components in the main control cabinet.

12. The battery swapping station according to claim 11, wherein an access opening is provided on the air-conditioning ventilation duct in an area corresponding to a control panel of the main control cabinet, a partition is provided between the charging chamber and the battery swapping chamber, and a main control door is provided on the partition in an area corresponding to the control panel of the main control cabinet, wherein the access opening is communicated with the main control door, and the main control door of the main control cabinet is designed to open towards the battery swapping chamber.

13. The battery swapping station according to claim 11, wherein a part of the air-conditioning ventilation duct is preset in the second expansion compartment, another part of the air-conditioning ventilation duct is preset in the charging chamber, and the two parts of the air-conditioning ventilation duct are connected and communicated through a flexible joint.

14. The battery swapping station according to claim 1, wherein the charging chamber is also provided with a ventilation duct for a charger, and the charger is provided with a plug-in end for electrically connecting to a battery on the charging rack, wherein one end of the ventilation duct for the charger is positioned facing a different side from the plug-in end of the charger, and the other end of the ventilation duct for the charger is communicated with the outside of the charging chamber through a fan.

15. The battery swapping station according to claim 14, wherein the charging chamber is provided with at least two sets of the ventilation ducts for the chargers, each facing a different side from the plug-in ends of the two sets of chargers, and located on a side of the charger away from a lifting area respectively, and the plug-in ends of the two sets of chargers are positioned opposite to each other, forming an operating area between the plug-in ends.

16. The battery swapping station according to claim 1, wherein a second material passage is provided between the first expansion compartment and the battery swapping chamber.

17. The battery swapping station according to claim 1, wherein the battery swapping chamber comprises an independent compartment at the top and a driving passage at the bottom, and the independent compartment is communicated with the first expansion compartment.

18. The battery swapping station according to claim 1, wherein the battery swapping station is provided with at least two battery swapping chambers arranged side by side in the running direction of the electric vehicle, opposite sides of each of the battery swapping chamber are provided with the charging chamber, end surfaces of the first expansion compartments located above each of the battery swapping chamber are connected, and a plurality of the first expansion compartments are internally communicated.

19. The battery swapping station according to claim 18, wherein a second expansion compartment is provided above the charging chamber, and the bottom of the second expansion compartment is communicated with the top of the charging chamber.

20. The battery swapping station according to claim 18, wherein a third expansion compartment is provided between the adjacent charging chambers along the running direction of the electric vehicle in the battery swapping station, and the third expansion compartment is provided with a passage door for the electric vehicle to drive out.
